(19) United States
(12) Patent Application Publication
(10) Pub. No.: US 2004/0236470 A1
(43) Pub. Date: Nov. 25, 2004

(54) Position and communications system and method

(76) Inventors: Mike Dooley, San Rafael, CA (US); Gaute Munch, Langa (DK)

Correspondence Address: Gerald Levy, Pitney Hardin Kipp & Szuch, 711 Third Avenue, New York, NY, 10017-4059, US

(21) Appl. No.: 10/478,984

(22) PCT Filed: May 27, 2002
(86) PCT No.: PCT/DK02/00357

(30) Foreign Application Priority Data
May 25, 2001 (DK) PA 2001 00844

(51) Int. Cl. G05D 1/02

(52) U.S. Cl. 700/255

(57) ABSTRACT

A system for providing communication of position information between moving bodies navigating in proximity of each other. Messages can be communicated via the same system. Orientation information is provided by transmitting infrared digital signals that are specific to individual zones around the moving body. By knowledge of the relation between the position of the zones and the specific signals an orientation can be deduced by a receiving body. Distance information is provided by transmitting infrared digital signals from a transmitter at respective power levels, at which power levels the signals comprise information for identifying the specific power level. By knowledge of the relation between the range of the zones and the specific signals a distance from a receiving body to the transmitter can be deduced. Direction information is provided by knowledge of the position of reception zones and signals received.

### FIELD OF THE INVENTION

This invention relates to methods and systems for transmitting and receiving information about the relative direction to, orientation of or distance to a body e.g. for use in toys.

### BACKGROUND OF THE INVENTION

Toy robots are a popular type of toy for children, adolescents and grown-ups. The degree of satisfaction achieved during the play with a toy robot strongly depends upon the ability of the toy robot to interact with its environment. An environment may include persons playing with a robot; different types of obstacles, e.g. furniture in a living room; other toy robots; and conditions such as temperature and intensity of light.

A toy robot repeating the same limited number of actions will soon cease to be interesting for the user. Therefore it is a major interest to increase the ability to interact with the environment. An interaction with the environment may comprise the steps of sensing the environment, making decisions, and acting.

A fundamental precondition for achieving such an aim of advanced interaction with the environment is the means for sensing the environment. In this context, means for communicating, for example with toy robots of the same or similar kind or species, and means for determining the position of such other toy robots are important.

The more developed means for sensing and acting a robot has, the more compound interaction it can have with the surrounding environment and the more detailed the reflection of the complexity in the environment will be. Thus, complex behaviour originates in rich means for sensing, acting and communicating.

Japanese laid-open patent application no. 2000-79283 discloses a light-following moving body provided with an infrared light receiver for receiving infrared light emitted from a transmitting body. The transmitting body is in the form of a toy ball with holes at equal intervals on its outer surface. Through each hole, a signal produced by an infrared ray transmitter is transmitted to its exterior. The moving body is in the form of toy car in which a control and drive mechanism is provided, whereby the moving body is caused to turn when the infrared light signal is not received, and is caused to move directly forward when the infrared signal is received.

However, this prior art system is only concerned with robots directly reacting on sensor inputs or simple communication signals received from other toy robots. Thus, this prior art system lacks the ability to locate a body with sufficient accuracy to enable that a moving body can be given a more compound behaviour.

Consequently, this system involves the disadvantage that the toy robots are not able to navigate among other robots with a behaviour, which a user may perceive as being intelligent.

U.S. Pat. No. 5,819,008 discloses a sensor system for preventing collisions between mobile robots and between mobile robots and other obstacles. Each mobile robot includes eight transmitting/receiving units each of which is arranged as a combined infrared signal transmitter and receiver for transmitting and receiving transmission data into/from different directions. The transmitting/receiving units are placed along the periphery of a circle with a mutual spacing of 45 degrees and orientated to transmit/receive to/from the outside of the circle. The transmission data includes identification information unique to a robot and directional information in the form of information for identifying one of the eight transmitters. Due to the spatial arrangement of the transmitting/receiving unit and the properties of the transmission data, a direction to a remote robot and the orientation of the remote robot can be deduced. Each robot further comprises a control unit, based on a decision matrix, which controls the mobile robot to perform predetermined collision avoidance movements depending on the orientation of another mobile robot and in which direction the other robot appears. The control unit is also able to detect obstacles by interpreting reception of its own unique identification as presence of an obstacle.

Despite it being disclosed that interference between the different signals emitted from a robot itself or one or several other robots can occur and despite a method for detecting interference being disclosed, no methods or means for avoiding or reducing interference is suggested. This is very likely to be a problem in a real-life situation—especially when more than one robot is present in the same room or otherwise in proximity of each other.

Since orientation information from other robots can be received within a radius of about 1 to 1.2 meters it is questionable whether close and thus exciting movement patterns between robots will occur. Additionally, more space for movement of the robots is required due to the simple sensor system.

Despite the simplicity and the drawbacks of the sensor system, the costs of producing such a sensor system will be relatively high due to the large number of sensors, ie two times eight transmitters/receivers. This is a high number especially for an electronic toy robot, since electronic toy robots are generally encumbered with a high price.

### SUMMARY OF THE INVENTION

The above-mentioned and other problems are solved by means of a system for transmitting information about the orientation of a robot, comprising: means for emitting signals to multiple zones at predetermined locations around and relative to the robot, wherein the signals carry information that is specific to the individual zones around the robot; wherein the information that is specific to the individual zones is time-multiplexed to multiple timeslots.

Thereby interference between the signals are avoided or at least reduced to a minimum. Since not all zones are irradiated simultaneously, signals emitted to other zones than a given zone and reflected by a remote body are less likely to interfere with the signals emitted directly to the given zone. Thereby the performance of the system is increased.

It is preferred that the information that is specific to the individual zones is emitted as a time-multiplexed signal divided both temporally and spatially into one or more zones.

When the means are arranged as individual emitters (202,203, . . . ,207) mounted with a mutual distance and at mutually offset angles, the signals can be emitted into the spatial zones without mechanical moving parts. For a toy robot it is preferred that the distance is about 20 to 40 mm or less than 100 mm.

It is preferred that an emitter is arranged to create a space within which a specified least intensity level for a signal that carries information specific for the zone is detectable. Thereby, when the specified least intensity level corresponds to a threshold value in a receiver, a receiver can detect presence in a zone by determining whether a received signal has a signal level above the threshold value. This allows for a simple and cost attractive solution for determining whether the robot is present in a zone.

Preferably, the emitters are arranged to create a zone within which a specified least intensity level for a first signal and a second signal can be measured, where the first and second signal carry information specific for a respective zone to thereby create a third zone as the common space of two zones. Consequently, an additional zone per two transmitters is created—other things being equal. This provides for an increased resolution of the transmitting system, that is for a given angular interval more zones or sectors can be established. It should be noted that it is assumed that an orientation is determined as presence or no presence in a zone and that the orientation thus is provided as a discrete value.

When the information that is specific to the third zone is composed of at least portions of the first signal and the second signal, specific information for the third zone is created by detecting a signal over a time-interval with length sufficient for receiving the specific information. This length can be equal to about the time-interval during which the specific information for the first and second signals is transmitted.

Preferably, the information that is specific to the third zone extends temporally over more than one timeslot (t3,t4;t6,t7).

When at least one emitter is controlled to transmit message-signals with information about the robot to other robots, other robots can receive this information at their own discretion and interpret the information according to their own rules. The rules—typically implemented as computer programs—can in turn implement a type of behaviour.

When a first robot is configured to wait for a situation where communication silence can be detected before a transmission of a signal is started, the risk of increasing interference between signals is reduced.

Preferably, the first robot is arranged to transmit the signals carrying information that is specific to individual zones in a sufficiently tight sequence to avoid that other similar robots in proximity of the first robot is able to detect a situation where communication silence is present. Consequently, each robot can complete a cycle of providing/emitting orientation information without being interrupted in that cycle by other robots. Since, typically, the orientation-transmitting robot is not aware of which of the signals are actually used for determining an orientation of the robot, it is hereby ensured that a complete cycle of orientation information is transmitted. In an expedient embodiment, a cycle comprises all of the signals specific for a zone.

The invention also relates to a system for receiving information about the orientation of a robot, comprising: means for receiving signals that carry information that is specific to one of multiple zones around and relative to the robot, and means for extracting the information specific to an individual zone and converting that information into information that represents the orientation of the robot; wherein the orientation of the robot is deduced by determining whether two signals that each carries information that is specific to one of multiple zones around and relative to the robot can be received in at least two consecutive timeslots; and, in the affirmative, combining the at least two signals to determine the orientation of the robot.

If two signals that each carries information that is specific to one of multiple zones around and relative to the robot cannot be received in at least two consecutive timeslots, determining the orientation of the robot based on the signal received in a first of the two consecutive timeslots. Such a situation indicates that the orientation of the robot is such that only one signal is available and consequently that the orientation should be interpreted accordingly. That is, the orientation corresponds to presence in a zone not established by two or more overlapping zones.

In a preferred embodiment the system further comprises program means for controlling physical actions of a robot in response to received signals that represent the position of another robot. This allows for programming advanced inter-robot movement strategies and/or inter-robot communication by registering/recognizing movement patterns of remote robots.

In a preferred embodiment the invention is comprised in a toy set comprising a toy robot. When the toy unit comprises coupling means for inter-connecting with complementary coupling means on toy building elements, it is possible to manipulate the toy unit e.g. to provide the toy unit with different types of movement means. The coupling means and the complementary coupling means can be embodied as disclosed in U.S. Pat. No. 5,645,463 assigned to Interlego AG and in which multiple types of connection means eg holes for supporting axles, connection studs and taps, and grips for snapping elements into interconnection are disclosed.

In the prior art it is a problem that only limited information for navigating/manoeuvring a robot among object bodies or other mobile robots is available. Lack of sufficient such information can lead to coarse movement patterns of the robots and to mobile robots needing more space for demonstrating a given movement interaction between the robots than would be necessary with more complete or adequate information about the position of object bodies or the other robots.

This and other problems are overcome according to a system for transmitting information about the distance between the system and a robot, comprising: means for emitting signals to the surroundings of the robot; wherein the means are controlled to emit the signals at respective power levels, at which power levels the signals comprise information for identifying the specific power level.

Consequently, information is transmitted to other robots for determining a distance to the transmitting robot. This distance is provided in discrete values depending on the number of respective power levels at which the information for identifying the specific power level is provided. In a preferred embodiment three power levels are provided, but two, four, five, . . . , ten or forty power levels could be provided. The power levels correspond to different maximum ranges within which the signals can be detected to have a signal level above a specified threshold. These ranges can be used to interpret a signal transmitted at a given power level and with information for identifying the specific power level as a corresponding distance interval However, this interval is not necessarily known in its metric size eg in meters or centimetres. Generally, it should be noted that the distance can be interpreted as a distance index due to the discrete resolution of a span of distances.

Preferably, the power levels are discrete power levels distributed as non-linear power levels. Thereby, ranges at which a higher distance resolution is required can be represented by more power levels than other ranges. This in turn will provide for limiting the number of required power levels.

Expediently, power levels of the signals or signal portions are mixed within a time-interval during which the information for identifying the specific power level is transmitted. Thereby, different time sequence patterns can be used for determining a power level and thus a distance.

When the signals each comprises a set of bits, which bits occur in a predetermined, but mixed sequence, a simple bit-pattern match can be used to determine a distance or distance index. Fast and simple logical circuits can implement this bit-pattern match.

When the system comprises means for emitting signals to multiple zones at predetermined locations around and relative to the robot, wherein the signals carry information that is specific to the individual zones around the robot, both orientation and distance information are provided.

Preferably, at least one emitter is controlled to transmit message-signals with information about the robot to other robots. Thereby, a common system for transmitting both position information and inter-robot messages including remote control signals can be used.

Preferably, a first robot is arranged to wait for a situation where communication silence can be detected before a transmission of a signal is started. This reduces the risk of destroying the quality of the inter-robot communication.

Preferably, the first robot is arranged to transmit the signals at the respective power levels in a sufficiently tight sequence to avoid that other similar robots in proximity of the first robot is able to detect a situation where communication silence (S) is present.

Additionally, the invention relates to a system for receiving information about the distance between the system and a transmitter, comprising: means for receiving signals with information for identifying a specific power level at which the signal is transmitted; and means for converting that information into information that represents distance between the system and a transmitter that transmits the signals.

Consequently, a distance can be determined simply by collecting or receiving information as opposed to transmitting a signal, waiting for a reflection of the transmitted signal to arrive and receiving the signal. Thus a cost attractive solution is provided.

Preferably, the system comprises means for converting a received signal into a binary signal based on a specified threshold value. This allows for an expedient adaptation to further processing by a microprocessor.

Preferably, means are provided for determining the distance as a discrete value by decoding a sequence of bits representing the received signal as a binary signal.

Preferably, the distance is provided as a digital value.

Preferably, the sequence of consecutive digital values represents non-linear distributed distances.

The invention, moreover, relates to a system for determining the direction to a robot, comprising: means for receiving a signal from a remote robot, and determining a direction to the remote robot by determining which of multiple receivers that received the signal; wherein a direction is determined as a direction from which two or more receivers can receive the signal.

Consequently, a number of directions, larger than the number of receivers, can be determined. Thereby a relatively high resolution of directions is provided at a relatively low price, since for a given required number of directions, a smaller number of receivers are required.

Preferably, a precondition for determining the direction is that the receivers can receive the signal simultaneously. Here, it is assumed that the time difference for a signal to at a first receiver and at a second receiver is small (less than 1 to 100), when compared to the duration of the signal for determining the direction.

### BRIEF DESCRIPTION OF THE DRAWINGS

The invention will be explained more fully below in connection with a preferred embodiment and with reference to the drawing, in which:

FIG. 1a shows a top-view of two robots and their spatial interrelationship;

FIG. 1b shows a top-view of a robot and zones defined by spatial irradiance characteristics of emitted signals;

FIG. 1c shows a top-view of a robot and zones defined by spatial sensitivity characteristics of received signals:

FIG. 1d shows a top-view of two robots each being in one of the others irradiance/sensitivity zone;

FIG. 1e shows a top-view of a robot and zones defined by spatially irradiance characteristics of signals emitted at different power levels;

FIG. 2 shows a toy robot with emitters emitting signals that are characteristic for each one of a number of zones that surrounds the robot;

FIG. 3 shows a robot with receivers for detecting signals emitted towards the robot from different and determinable directions;

FIG. 4 shows irradiance curves for four emitters mounted on a robot;

FIG. 5a shows the power levels used for transmitting ping-signals at two different power levels;

FIG. 5b shows the power levels used for transmitting ping-signals at three different power levels;

FIG. 6 shows a state event diagram for transmitting ping signals that are characteristic for each one of four transmitters and transmitted at low and medium power levels;

FIG. 7 shows a state event diagram for transmitting ping signals at high power level;

FIG. 8 shows a state event diagram for transmitting ping signals at low, medium and high power level comprising information enabling determination of orientation and distance, along with inter-robot messages;

FIG. 9 shows a block diagram for transmitting ping-signals and messages;

FIG. 10 shows sensitivity curves for two receivers mounted on a robot;

FIG. 11 shows a block-diagram for a system for receiving ping-signals and message signals;

FIG. 12 shows a block-diagram for a robot control system,

FIG. 13 shows three robots in a partially confined space;

FIG. 14 shows a block-diagram of a toy robot;

FIG. 15 shows a toy robot with emitters emitting signals that are characteristic for each one of a number of zones that surround the robot;

FIG. 16a shows the power levels used for transmitting ping-signals by a robot at three different power levels;

FIGS. 16b-e show the power levels for transmitting ping-signals by different diode emitters of a robot; and

FIG. 17 shows a block diagram for transmitting ping-signals and messages.

### DETAILED DESCRIPTION OF PREFERRED EMBODIMENTS

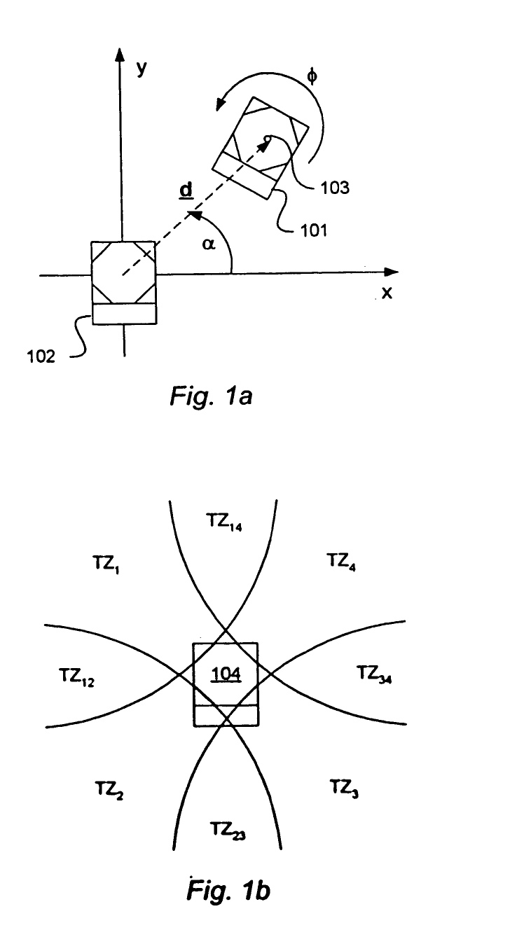

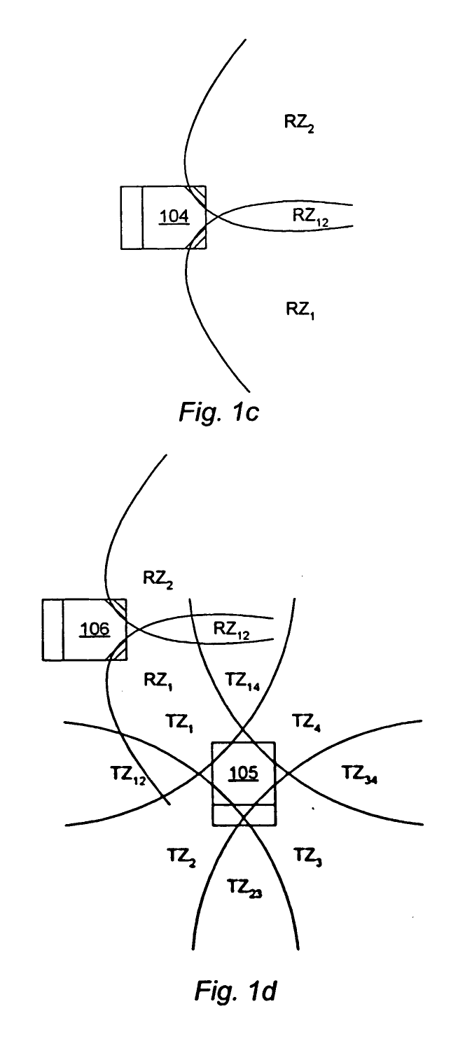

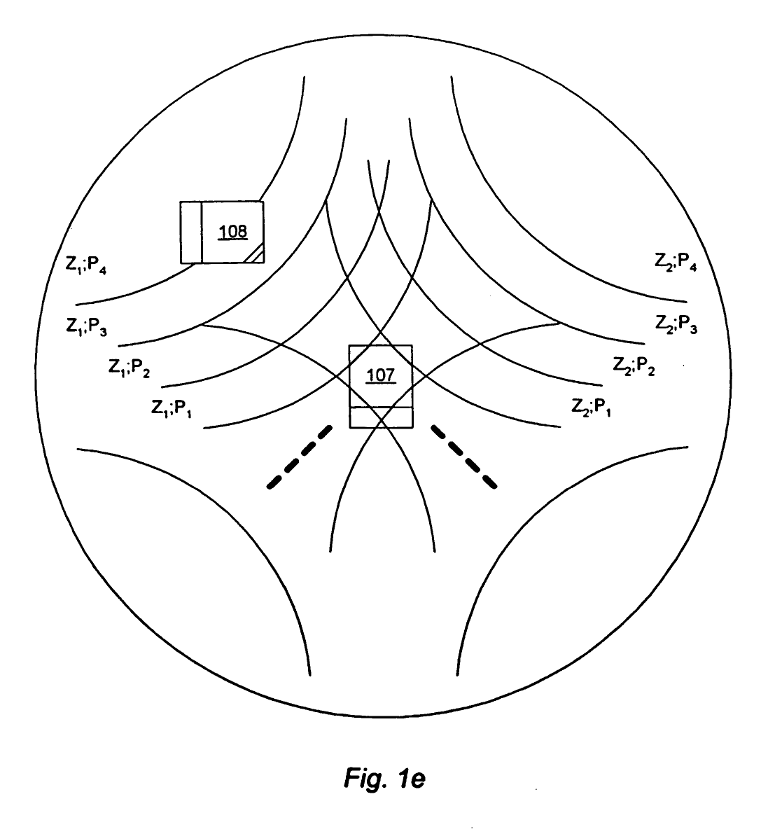

FIG. 1a shows a top-view of a first robot and a second robot, wherein the relative position, distance, and orientation of the two robots are indicated. In order to describe this spatial relationship between the two robots, the second robot 102 is positioned in the origin of a system of coordinates with axes x and y. The first robot 101 is positioned a distance d away from the second robot 102 in a direction α relative to the orientation of the second robot. The orientation (i.e. an angular rotation about a vertical axis 103) of the first robot relative to the second robot can be measured as φ.

If knowledge of d, α, and φ is available in the second robot 102 it is possible for the second robot 102 to navigate in response to the first robot 101. This knowledge can be used as input to a system that implements a type of inter-robot behaviour. The knowledge of d, α, and φ can be maintained by a robot position system. d, α, and φ can be provided as discrete signals indicative of respective types of intervals i.e. distance or angular intervals.

According to the invention and as will be described more fully below, the knowledge of d, α, or φ is obtained by emitting signals into respective confined fields around the first robot where the respective signals carry spatial field identification information. The second robot is capable of determining d, α, and/or φ when related values of the spatial field identification information and respective fields can be looked up.

The emitted signals can be in the form of infrared light signals, visible light signals, ultra sound signals, radio frequency signals etc.

It should be noted that the above-mentioned fields are denoted zones in the following.

FIG. 1b shows a top-view of a robot and zones defined by spatial irradiance characteristics of emitted signals. The robot 104 is able to transmit signals TZ₁, TZ₁₂, TZ₂, TZ₂₃. TZ₃ TZ₃₄, TZ₄ and TZ₁₄ into respective zones that are defined by the irradiance characteristics of four emitters (not shown). The emitters are arranged with a mutual distance and at mutually offset angles to establish mutually overlapping irradiance zones around the robot 104. When the signals TZ₁, TZ₁₂, TZ₂, TZ₂₃, TZ₃, TZ₃₄, TZ₄ and TZ₁₄ can be identified uniquely from each other and when a signal can be received it is possible to deduce in which of the zones the signal is received. This will be explained in more detail.

FIG. 1c shows a top-view of a robot and zones defined by spatial sensitivity characteristics of received signals. The robot 104 is also able to receive signals RZ₁, RZ₁₂, and RZ₂ typically of the type described above. The receivers are also arranged with a mutual distance and at mutually offset angles to establish mutually overlapping reception zones around the robot 104. With knowledge of the position of the reception zone of a corresponding receiver or corresponding receivers the direction from which the signal is received can be determined. This will be explained in more detail also.

FIG. 1d shows a top-view of two robots each being in one of the others irradiance/sensitivity zone. The robot 106 receives a signal with a front-right receiver establishing reception zone RZ₁. Thereby the direction of a robot 105 can be deduced to be in a front-right direction. Moreover, the orientation of the robot 105 can be deduced in the robot 106 it the signal TZ₁ is identified and mapped to the location of a spatial zone relative to the robot 105. Consequently, both the direction to the robot 105 and the orientation of the robot 105 can be deduced in the robot 106. To this end the robot 105 must emit signals of the above-mentioned type whereas the robot 106 must be able to receive the signals and have information of the irradiance zones of the robot 105. Typically, both the transmitting and receiving system will be embodied in single robot.

FIG. 1e shows a top-view of a robot and zones defined by spatially irradiance characteristics of signals emitted at different power levels. The robot 107 is able to emit zone-specific signals as illustrated in FIG. 1b with the addition that the zone-specific signals are emitted at different power levels. At each power level the signals comprise information for identifying the power level. The robot 107 thereby emits signals with information specific for a zone (Z₁, Z₂, . . . ) and a distance interval from the robot 107. A distance interval is defined by the space between two irradiance curves e.g. (Z1;P2) to (Z1;P3).

If a robot 108 can detect information identifying zone Z₁ and identifying power level P₄ but not power levels P₃, P₂ and P₁, then it can be deduced by robot 108 that it is present in the space between (Z₁;P₄) and (Z₁;P₃). The actual size of the distance between the curves (e.g. (Z₁;P₄) and (Z₁;P₃)) is determined by the sensitivity of a receiver for receiving the signals and the power levels at which the signals are emitted.

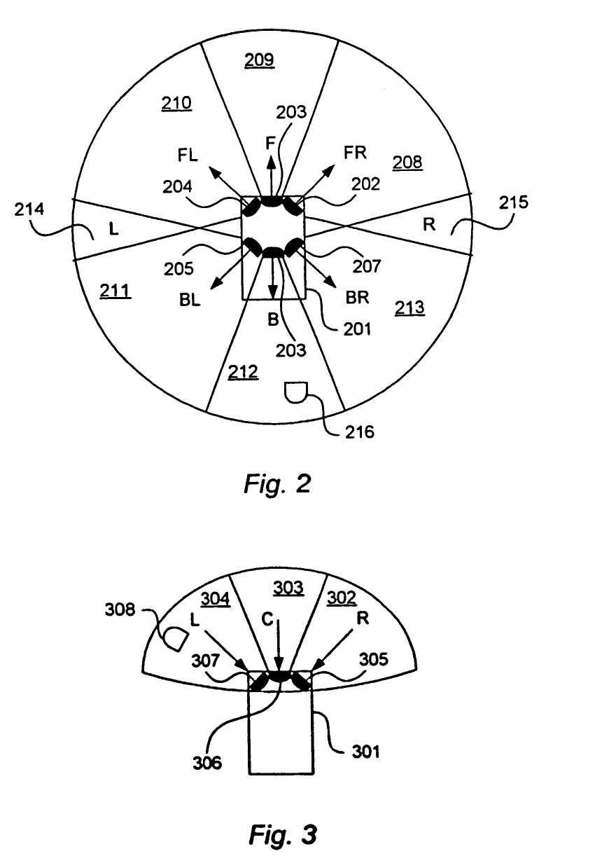

FIG. 2 shows a robot with emitters emitting signals that are characteristic for each one of a number of zones that surround the robot. The robot is shown with an orientation where the front of the robot is facing upwards.

The robot 201 comprises six infrared light emitters 202, 203, 204, 205, 206 and 207 each emitting a respective infrared light signal FR. F, FL, BL, B and BR. Preferably, the emitters are arranged to emit light at a wavelength between 940 nm and 960 nm.

The infrared light emitters 202, 203, 204, 205, 206 and 207 are mounted on the robot at different positions and at different angles to emit infrared light into the zones 208, 209, 210, 211, 212 and 213 surrounding the robot. The zones 210 and 211 overlap each other to establish a further zone 214; similarly the zones 213 and 208 overlap to establish a zone 215. The zones are defined by adjusting the radiation aperture (e.g by a shield adapted to confine the radiance of an emitter to a desired spatial zone) and the above-mentioned position and angle of the individual emitters—and the power of infrared light emitted by the emitters.

Each of the infrared signals F, Fl, BL, B, BR, and FR are encoded with information corresponding to a unique one of the infrared emitters thereby corresponding to respective zones of the zones surrounding the robot.

The infrared signals are preferably arranged as time-multiplexed signals wherein the information unique for the infrared emitters is arranged in mutually non-overlapping time slots. This is illustrated in table 1 below. Preferably, the time-multiplexed signals are transmitted in a tight sequence to thereby avoid that other robots can detect communication silence during the time-interval defined by timeslot t1 through t7.

TABLE 1

| | timeslots | | | | | | |
|---|---|---|---|---|---|---|---|
| zone | t1 | t2 | t3 | t4 | t5 | t6 | t7 |
| 208 | FR | 0 | 0 | 0 | 0 | 0 | FR |
| 209 | 0 | F | 0 | 0 | 0 | 0 | 0 |
| 210 | 0 | 0 | FL | 0 | 0 | 0 | 0 |
| 214* | 0 | 0 | FL | BL | 0 | 0 | 0 |

=L

| | | | | | | | |
|---|---|---|---|---|---|---|---|
| 211 | 0 | 0 | 0 | BL | 0 | 0 | 0 |
| 212 | 0 | 0 | 0 | 0 | B | 0 | 0 |
| 213 | 0 | 0 | 0 | 0 | 0 | BR | 0 |
| 215* | FR | 0 | 0 | 0 | 0 | BR | FR |

=R

Table 1 shows the time-multiplexing of the signals FR, F, FL, BL, B and BR. It is shown that signals FL and BL are both detectable in the zone 214. Likewise, the signals BR and FR are both detectable in the zone 215.

In order to be able to determine, based on the signals, in which of the zones a detector is present a detector system is provided with information of the relation between zone location and a respective signal.

However, in order to determine in which of the over-lapping zones a detector is present, a detector system can be made able to detect at least up to two consecutive signals (BR, FR; FL, BL) within a period of six time slots. Thereby the zone 215 can be identified as the zone where the signals FR and BR are successively detectable as a signal R. Likewise; the zone 214 can be identified as the zone where the signals FL and BL are successively detectable as a signal L. Although this principle is preferred other detection principles can be used.

Consequently, the orientation of the robot 201 relative to an infrared light detector 216 faced towards the robot 201 can be determined. In a preferred embodiment such a detector is mounted on another robot, which thereby is provided with means for detecting the orientation of the robot 201.

In the situation shown, an infrared light detector 216 is within the zone 212 to receive the signal B, which in turn can be decoded as presence in the zone 212 by means of table 1.

If the orientation of the robot 201 is changed clockwise about 90′, that is the robot is turned about it's centre vertical axis, the detector will be present in the zone 215. This presence can be determined when both the signal FR and BR can be detected—and when it is known that the signal FR is emitted from the front-right emitter and the signal BR is emitted from the back-right emitter.

Received signals can be decoded by means of a table (e.g. table 1) with interrelated values of signal types and location of a corresponding zone with respect to the robot 201. The signal type is used as an entry to the table consequently giving the location of a corresponding zone as a result.

Since the signals are transmitted as time-multiplexed signals (as set forth in table 1 above), the likelihood of receiving distorted signals is reduced. If time multiplexing was not applied, a signal transmitted directly to a receiver in a given zone could be distorted by a signal transmitted to another zone, but reflected by an object (eg a wall). This would destroy the performance of the position system.

FIG. 3 shows a robot with receivers for detecting signals emitted towards the robot from different and determinable directions. The robot 301 comprises three infrared light receivers 305, 306 and 307 each associated with a zone 302, 303 and 304, respectively, representing zones within which the receivers are capable of detecting infrared light emitted towards the receivers at a power level above a specified threshold level.

The infrared light receivers 305, 306 and 307 are mounted on the robot at different positions and at different angles. The zones are defined by arranging the position, orientation, infrared light sensitivity and/or the light influx aperture of the individual receivers.

Thereby, the direction at which an emitter 308 emitting infrared light towards the front face of the robot 301 appears, can be determined. The direction is determined in the form of a response that indicates detection of an infrared signal from one or more of the receivers 305, 306 and/or 307.

In the situation shown, the emitter 308 is within the zone 307. The robot 301 is thus receiving a response from the receiver 307 indicating that an emitter is present in the zone 304 and in turn that the emitter is present in a front-left direction relative to the robot 301.

Table 2 below shows examples of how signals received in the robot 301 can be decoded to extract orientation and direction information for the robot 201.

TABLE 2

| detector | signal | | orientation | direction |
|---|---|---|---|---|
| 306 | B | [symbol] | N | centre-front |
| 306 | R | [symbol] | E | centre-front |
| 307 | F | [symbol] | S | left-front |

The first example in table 2 shows that the detector 306 receives a signal B. With the knowledge of relation between emitted signals and respective zones, the direction to the robot 201 can be determined by simply identifying the detector that has received the signal B—in this example the detector 306. This direction is indicated as ‘centre-front’. The orientation of the robot 201 is indicated with a capital N for north. In the second and third examples the orientation is stated with a capital E for east and a capital S for south, respectively.

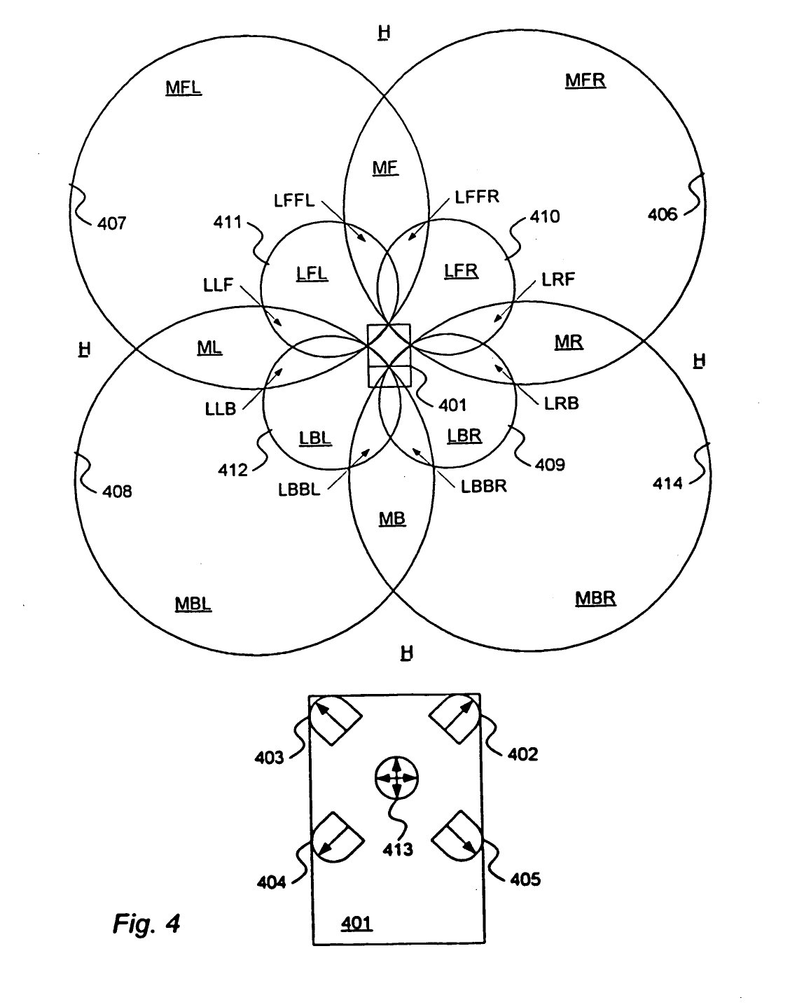

FIG. 4 shows irradiance curves for four emitters mounted on a robot. The robot 401 with the four emitters 402, 403, 404 and 405 is shown below the irradiance curves in an enlarged view. On the enlarged view a further emitter 413 is shown; this emitter is arranged to emit a signal at a high power level to the surroundings of the robot. Since this signal is likely to be reflected from objects such as walls, doors etc., a corresponding irradiance curve is not shown—instead a capital H indicates this irradiance.

The irradiance curves show that each of the emitters are controlled to emit infrared light at two different power levels; in the following these two power levels will be referred to as a low power level (prefix ‘L’) and a medium power level (prefix ‘M’).

The relatively large irradiance curves 406, 407, 408 and 414 represent zones within which a receiver is capable of detecting infrared light signals MBR, MFR, MFL and MBL emitted towards the receiver when one of the transmitters is transmitting at a medium power level. Likewise, the relatively small irradiance curves 409, 410, 411 and 412 represent zones within which a receiver is capable of detecting infrared light signals LBR, LFR, LFL and LBL emitted towards the receiver when one of the transmitters is transmitting at a low power level. The relatively large curves 406, 407, 408 and 414 have a diameter of about 120-160 cm. The relatively small curves 409, 410, 411 and 412 have a diameter of about 30-40 cm. High-power ping-signals should be detectable in a typical living room of about 6×6 metres.

Thus, the emitters 402, 403, 404 and 405 are arranged such that when operated at a medium power level (M), they establish mutual partly overlapping zones 406, 407, 408 and 409. Additionally, when the emitters 402, 403, 404 and 405 are operated at a low power level (L), they establish mutual partly overlapping zones 410, 411, 412 and 413. This allows for a more accurate determination of the orientation of the robot 401.

The emitters 402, 403, 404 and 405 are arranged to emit mutually non-overlapping time-multiplexed signals according to the principle shown in table 1. However, in order to manage the two power levels low and medium as opposed to one power level only, the time slot allocated to an emitter can be divided into two sub-slots. This in turn puts extra load on the transmitting position system.

This problem is solved when the signals transmitted by a respective transmitter at a medium power level comprise information unique for the transmitter in a first sub-timeslot. In a succeeding and shorter sub-timeslot a signal comprising information for distinguishing a medium power level zone from a low power level zone is transmitted at a low power level.

TABLE 3

| | | timeslots | | | | | | |
|---|---|---|---|---|---|---|---|---|
| IR | | t1 | | t2 | | t3, t4 | t5 | |
| emitter | zone | t1a | t1b | t2a | t2b | — | t7a | t7b |

| | | | | | | | |
|---|---|---|---|---|---|---|---|
| 402 | 406 | MFR | 0 | 0 | 0 | — | — |
| | 410 | MFR | LFR | 0 | 0 | — | — |

| | | | | | | |
|---|---|---|---|---|---|---|
| 403 | 407 | 0 | MFL | | 0 | — |
| | 411 | 0 | MFL | LFL | 0 | — |

Table 3 shows the time-multiplexing of the signals MFR, LFR and MFL, LFL Emitted by the transmitters 402 and 403, respectively. The signals emitted by The transmitters 404 and 405 are omitted in the table.

In the following, the infrared light emitters 402, 403, 404 and 405 and the power level (low or medium) at which they are operated are associated with a signal.

TABLE 4

| IR emitter | | | |
|---|---|---|---|
| reference | Power | | |
| numeral | level | signal | Description |
| 302 | Low | LFR | Front right emitter |
| 303 | Low | LFL | Front left emitter |
| 305 | Low | LBR | Back right emitter |
| 304 | Low | LBL | Back left emitter |
| 302 | Medium | MFR | Front right emitter |
| 303 | Medium | MFL | Front left emitter |
| 305 | Medium | MBR | Back right emitter |
| 304 | Medium | MBL | Back left emitter |

Table 4 shows relations between IR emitters, their position, the signal they are emitting and the power level at which the signals are emitted.

In order for a transmitting robot to encode orientation information and transmit the information into the zones for subsequent decoding and interpretation in other—receiving robots—a network protocol is used. The network protocol is based on ping-signals and message signals. These signals will be described in the following.

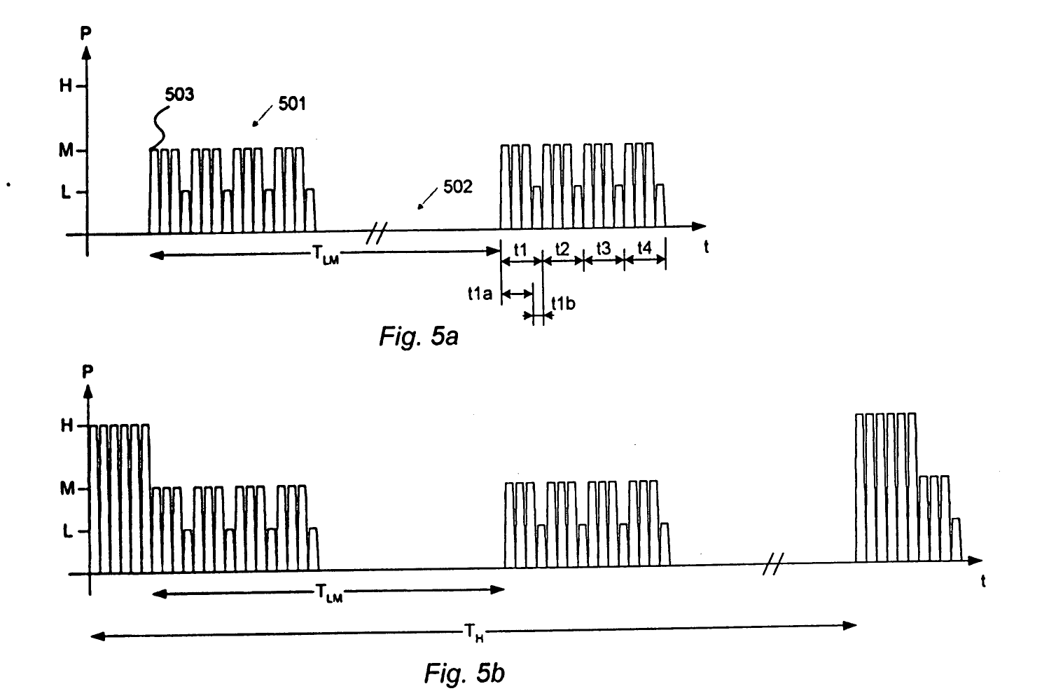

FIG. 5a shows the power levels used for transmitting ping-signals from four respective emitters. The power levels P are shown as a function of time t at discrete power levels L, M and H.

The ping-signals MFR,LFR; MFL,LFL; MBL,LBL; MBR,LBR for each of the four emitters are transmitted in a tight sequence 501. The sequence 501 is transmitted in a cycle with a cycle time T_{LM}, leaving a pause 502 between the tight sequences 501. This pause is used to allow other robots to transmit similar signals and/or for transmitting other information—e.g. message signals.

A ping-signal from an emitter comprises three bytes transmitted at medium power (M) followed by one byte transmitted at low power (L). The three first bytes are denoted: Init, ID and CRC. The last byte is the CRC byte retransmitted at low power.

A low/medium ping-signal using the notation in table 4 can be written as:

MFR_{Init}, MFR_{ID}, MFR_{CRC}, LFR_{CRC}.

where the subscript indicates the type of bytes (Init, ID, and CRC).

The content of these bytes can be changed from one transmission to the next. The three first bytes are transmitted in a timeslot t1a; the last byte is transmitted in a timeslot t1b. Similarly, the timeslots t2-t3 can be divided into a and b sub-timeslots. The spatial relation of the zones contra the ping-signals and the timeslots is shown in table 1.

FIG. 5b shows the power levels used for transmitting ping-signals at three different power levels The power levels P are shown as a function of time t. In addition to the ping-signals transmitted at low and medium power, high power ping-signals are transmitted. High power ping-signals are transmitted for every four low/medium power ping-signals that is, with a repetition time T_{H}; that is, T_{H}=4*T_{LM}

The high power ping-signals are transmitted at a sufficiently high power to be detectable by detectors (on other robots) which may be outside the well-defined zones.

High power ping-signals comprise eight bytes: INIT, ping-ID, global net ID (three bytes), message (two bytes) and CRC. The CRC byte is a Cyclic Redundancy Check byte. The INIT byte comprises information for determining the following sequence of bytes as being a high power ping-signal. The ping-ID and global net ID bytes comprise information for identifying the robot transmitting the high-power ping-signal within a community of maximally 2⁸ robots or 2²⁴, respectively. The global net ID bytes can also be used for uniquely identifying robots communicating via the Internet. The message bytes are used for broadcasting massages. Such broadcast messages can comprise information of an actual movement e.g. indicating that the robot is moving fast forward, is turning right, etc.

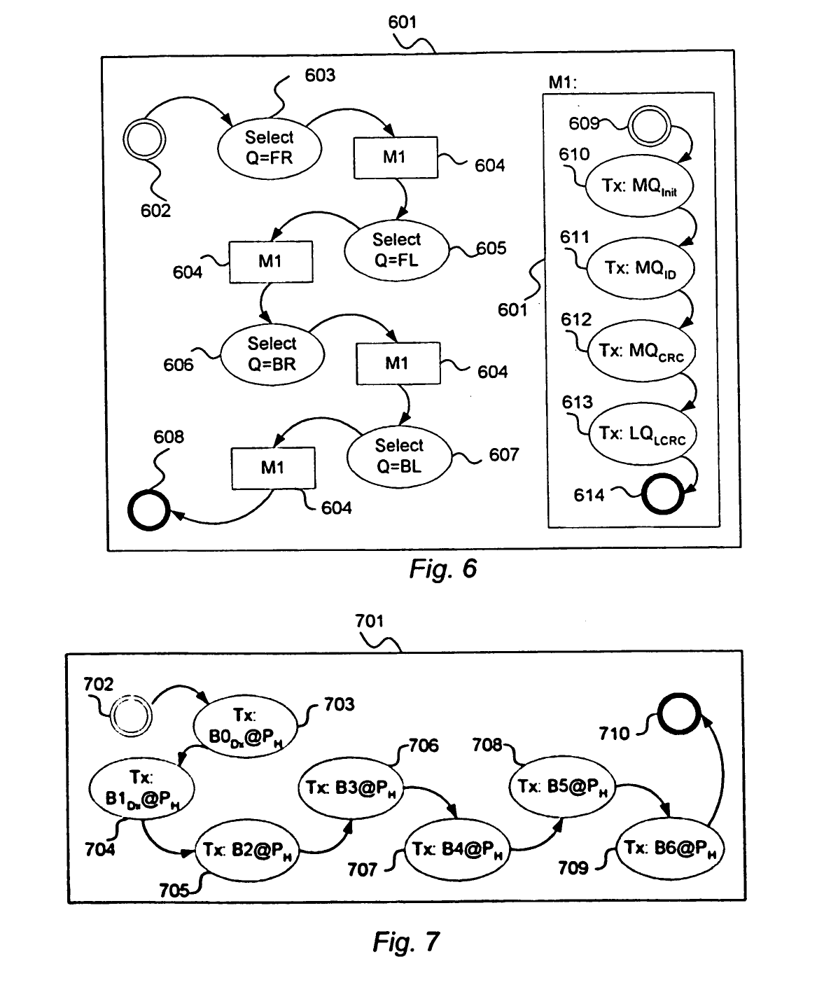

FIG. 6 shows a state event diagram for a state machine for transmitting ping-signals that are characteristic for each one of four transmitters and transmitted at low and medium power levels. The state machine 601 has a start state 602 from which an unconditional transition sets the active state to state 603. The state 603 and the states 605, 606 and 607 are used to select one of the emitters 402, 403, 404 and 405, respectively. In the state machine this is carried out by setting a variable 0 equal to either of ‘FR’, ‘FL’, ‘BR’ or ‘BL’. Each of these states has an unconditional transition to a sub-machine 604. The sub-machine 604 has a start state 609, a stop state 614 and four intermediate states 610, 611, 612 and 613 for transmitting the bytes INIT, ID, CRC and LCRC, respectively, at either the medium or low power level. In the intermediate states the respective bytes are read out from a memory (not shown). The states in the submachine are connected by unconditional state transitions. When the stop state is reached, the task of transmitting one ping-sequence 501 is completed.

FIG. 7 shows a state event diagram for a state machine for transmitting ping signals at high power level. The state machine 701 comprises a start state 702, a stop state 710 and intermediate states 703, 704, 705, 706, 707, 708 and 709. In the intermediate states, firstly, the centre emitter 413 is selected by setting 0=C; secondly, the bytes B1, B2, B3, B4, B5 and B6 are read out from a memory (not shown) and transmitted successively by the emitter 413 at a high power level.

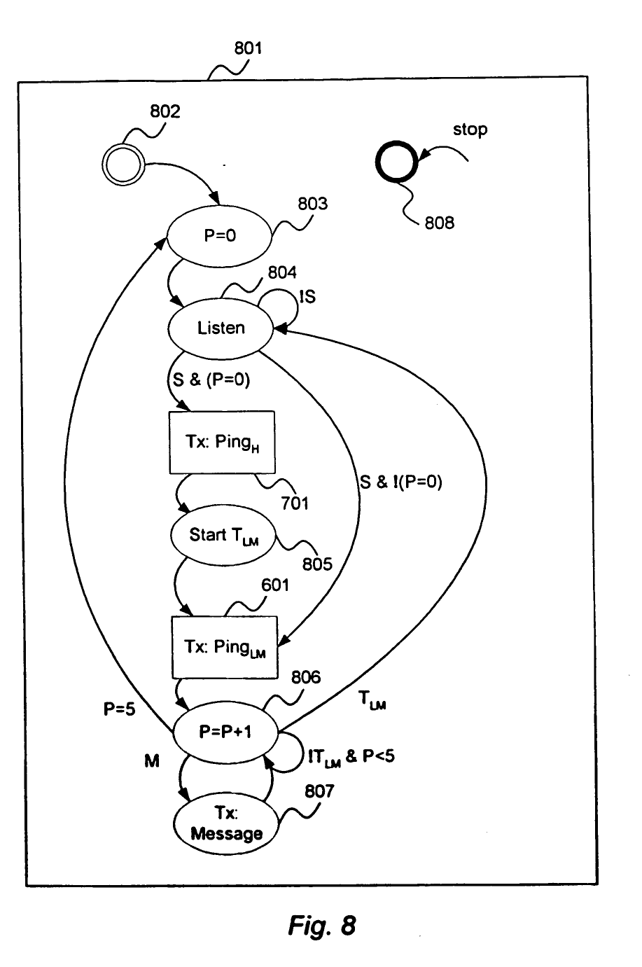

FIG. 8 shows a state event diagram for a state event machine for transmitting ping-signals at low, medium and high power level comprising information enabling determination of orientation and distance, along with inter-robot messages. The State machine 801 is using the machines 601 and 701 to transmit the ping-signals shown in FIG. 5b—and can also transmit message signals.

The state machine 801 has a start state 802 and a stop state 808. When first started, the state machine is intended to continue in real time or pseudo real time in order to ensure proper timing of the transmitted ping-signals. However, the machine may go to the stop state 808 when the robot is turned into a standby mode, if supply power is turned off or lost, etc.

Unconditionally and immediately after the start state 802, the state machine will go to the state 803 wherein the variable P is set equal to 0. The variable is used to count the number ping-signals to be transmitted at low/medium power levels between two consecutive high power ping-signals. An unconditional transition to the state 804 will bring the state machine into a wait-state, to wait for a pause in ping- and message signals traffic from other robots—i.e. communication silence—this is represented by the Boolean variable S. As long as ping- or message signals are received S is false and the machine will stay in the wait-state 804. When S shifts from false to true, a pause is detected. Communication silence can be defined as a situation where no signals are received or where signals received are below a specified or adaptive amplitude threshold value. A further condition for communication silence can be that the signals received are below a specified or adaptive amplitude threshold value over a specified time interval eg corresponding to the duration of 2, 2½, 3, 3½, 4 bits.

With the Criterion of communication silence being defined over a time interval (of eg 2 bits), the previously mentioned ‘tight sequence’ of can be defined as being a sequence wherein no communication silence occurs.

If, moreover, P is equal to 0, a conditional transition with the Boolean condition (S & (P=0)) will bring the state machine into, firstly, the state machine 701 for transmission of high power ping signals and, secondly, via the state 805 into the machine 601 for transmission of low/medium power ping messages. Consequently, the tight sequence 504 of ping-signals is transmitted.

When the tight sequence 504 is transmitted, the variable P is increased by the value 1 in state 806. If the message flag m is set, messages in a message queue (not shown is transmitted as a message signal) as a trailing sequence of the tight sequence 504. When the messages are sent, if any, the state machine returns to state 806 to wait for the timer started in state 805 to lapse. When the timer lapses T_{LM} is true and the state machine is brought to the state 804 to wait for communication silence. Now, P is not equal to 0, so when silence is detected (i.e. S gets true) a transition will bring the machine directly to state 601 to transmit a low/medium ping-signal 501. Subsequently, P is increased by one in state 806. Transmission of low/medium power level ping-signals will continue until four low/medium power level ping-signals have been transmitted (i.e. P is less than 5). When four low/medium power level ping-signals have been transmitted a high power ping-signal will be transmitted and the process continues over again.

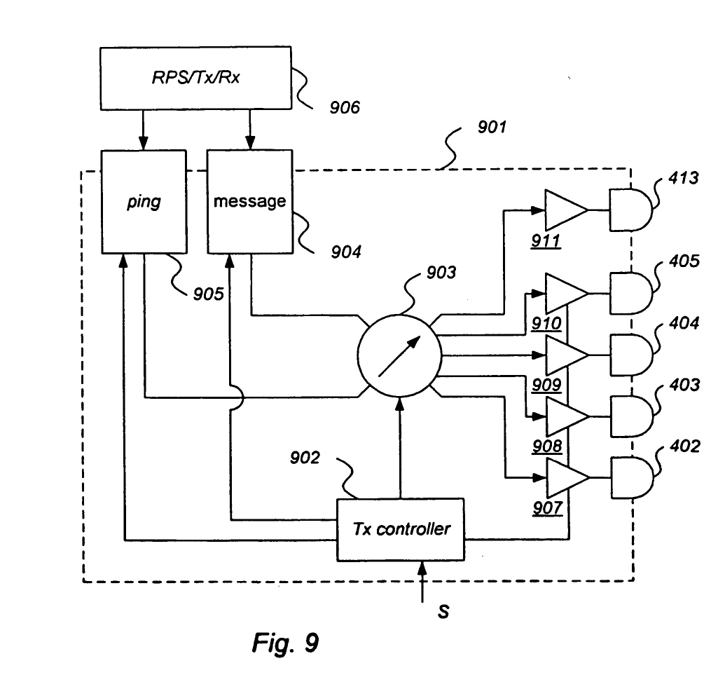

FIG. 9 shows a block diagram for a communications system for transmitting ping-signals and message-signals. The system 901 receives ping-signals (e.g. the bytes Init, ID and CRC) and message signals via a ping-signal buffer 905 and a message buffer 904, respectively. The ping- and message-signals are provided by an external system (not shown). The communications system 901 is thus able to receive information from the external system, which in turn can be operated asynchronously of the communications system.

The controller 902 is arranged to execute instructions in the state machine 801 and in turn the state machines 601 and 701.

Data in the buffers 904 and 905 are read out by specifying an address in the buffers. The addressed data are then routed to one or more of the infrared light transmitters 402, 403, 404, 405 and 413 via amplifiers 907, 908, 909, 910 and 911 by means of the selector 903. The selector 903 is controlled by the controller 902. The power levels emitted by the emitters 402, 403, 404 and 405 are controlled by adjusting the amplification of the amplifiers 907, 908, 909 and 910. The signal S provided to the controller is a binary signal indicative of whether there is communication silence that is, no other signals that possibly might interfere with signals to be emitted are detectable.

Thereby a system for emitting signals as shown in FIGS. 4 and 5a, 5b is disclosed. Moreover, the system can transmit general communication signals i.e. message-signals.

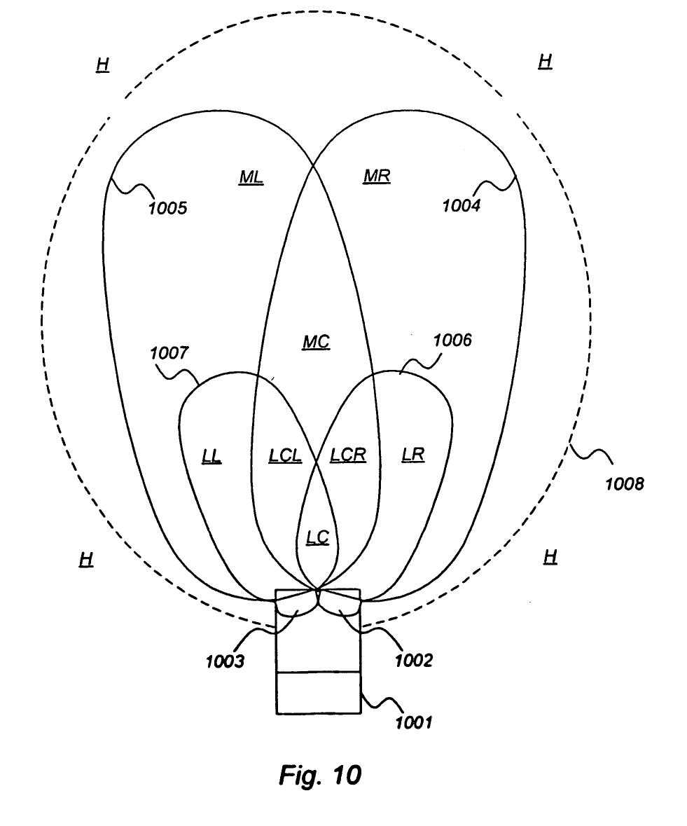

FIG. 10 shows sensitivity curves for two receivers mounted on a robot. The curve 1004 defines the zone in which a signal transmitted towards the receiver 1002 at medium power level can be detected by the receiver 1002. The curve 1006 defines a smaller zone in which a signal transmitted towards the receiver 1002 at low power level can be detected by the receiver 1002.

The curves 1005 and 1007 defines zones in which a signal transmitted towards the receiver 1003 at medium and low power level, respectively, can be detected by the receiver. Generally, the above-mentioned zones are denoted reception zones. A zone in which a signal transmitted towards the receiver 1003 at high power can be detected by the receiver is more diffuse; therefore such a zone is illustrated with the dotted curve 1008.

Since the emitters 402, 403, 404 and 405 transmit signals with information representative of the power level at which the signals are transmitted, the direction and distance to the position at which another robot appears can be determined in terms of the zones H, ML MC, MR, LL, LCL, LC, LCR and LR.

One or both of the two receivers 1002 and 1003 on a first robot can receive the signals emitted by the emitters 402, 403, 404, 405—and 413 on a second robot.

Consequently, a fine resolution of distance, direction and orientation can be obtained with a simple transmitting/receiving system.

Decoding Direction and Distance

In the following it is more fully described how to decode direction and distance information. It is assumed that:

if one receiver gets high power ping-signals, so does the other;

if a receiver gets low power ping-signals, it also gets medium and high power pings;

if a receiver gets medium power ping-signals, it also gets high power ping-signals.

Applying the notation: L for low power ping-signals, M for medium power ping-signals, and H for high power ping signals; a zone of presence can be determined based on received signals according to table 5 below:

TABLE 5

| left receiver | right receiver | |
|---|---|---|
| (1003) | (1002) | Zone |
| no signal | no signal | no robot present |
| H | H | H |
| H-M | H | ML |
| H-M | H-M | MC |
| H | H-M | MR |
| H-M-L | H | LL |
| H-M-L | H-M | LCL |
| H-M-L | H-M-L | LC |
| H-M | H-M-L | LCR |
| H | H-M-L | LR |

Table 5 shows how the encoded power level information in transmitted ping-signals can be decoded into presence, if any, in one of the ten zones in the left column. A zone is in turn representative of a direction and a distance.

Decoding Orientation

For the purpose of decoding orientation information table 6 and 7 below can be used.

At Medium Distance:

TABLE 6

| received ping-signals | | | | | | | | |
|---|---|---|---|---|---|---|---|---|
| MFL | MFR | MBR | MBL | LFL | LFR | LBR | LBL | zone |
| x | | | x | | | | | ML |
| x | | | | | | | | MFL |
| x | x | | | | | | | MF |
| | x | | | | | | | MFR |
| | x | x | | | | | | MR |
| | | x | | | | | | MBR |
| | | x | x | | | | | MB |
| | | | x | | | | | MBL |

Table 6 shows how received medium power ping-signals are related to a zone.

At Low Distance:

TABLE 7

| received ping-signals | | | | | | | | |
|---|---|---|---|---|---|---|---|---|
| MFL | MFR | MBR | MBL | LFL | LFR | LBR | LBL | zone |
| x | | | x | | | | x | LLB |
| x | | | x | x | | | x | LL |
| x | | | x | x | | | | LLF |
| x | | | | x | | | | LFL |
| x | x | | | x | | | | LFFL |
| x | x | | | x | x | | | LF |
| x | x | | | | x | | | LFFR |
| | x | | | | x | | | LFR |
| | x | x | | | x | | | LRF |
| | x | x | | | x | x | | LR |
| | x | x | | | | x | | LRB |
| | | x | | | | x | | LBR |
| | | x | x | | | x | | LBBR |
| | | x | x | | | x | x | LB |
| | | x | x | | | | x | LBBL |
| | | | x | | | | x | LBL |

Table 7 shows how received low and medium power ping-signals are related to a zone.

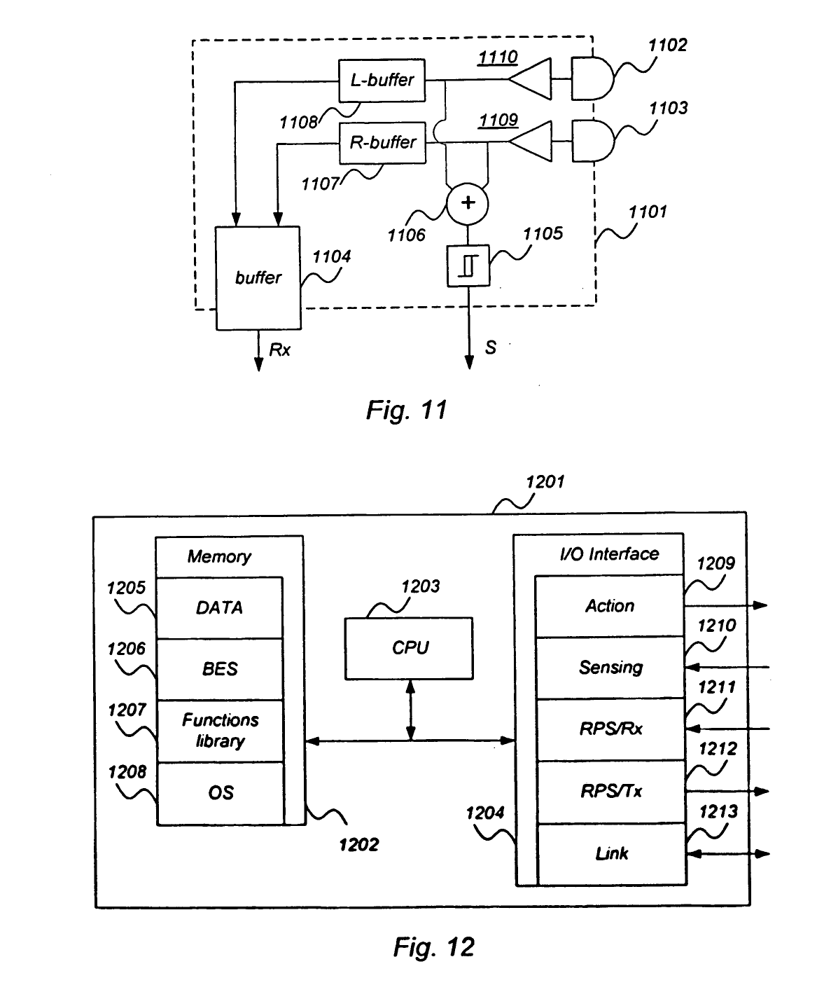

FIG. 11 shows a block-diagram for a system for receiving ping-signals and message-signals. The system 1101 comprises two infrared receivers 1102 and 1103 for receiving inter-robot signals (especially ping-signals and message-signals) and remote control signals.

Signals detected by the receivers 1102 and 1103 are provided as digital data by means of data acquisition means 1110 and 1109 in response to arrival of the signals, respectively. The digital data from the data acquisition means are buffered in a respective first-in-first-out buffer, L-buffer 1108 and R-buffer 1107. Data from the L-buffer and R-buffer are moved to a buffer 1104 with a larger capacity for accommodating data during transfer a control system (not shown).

The binary signal S indicative of whether infrared signals are emitted towards the receivers 1102 and 1103 is provided via a Schmitt-trigger 1105 by an adder 1106 adding the signals from the data acquisition means 1109 and 1110. Thereby the signal is indicative of whether communication silence is present.

The system can be controlled to receive signals from a remote control unit (not shown). In that case, the data supplied to the buffer is interpreted as remote control commands. Thereby, the receivers 1102 and 1103 may be used for receiving ping-/message-signals as well as remote control commands.

FIG. 12 shows a block-diagram for a robot control system. The control system 1201 is arranged to control a robot that may exhibit some type of behaviour. The control system 1201 comprises a central processing unit (CPU) 1203, a memory 1202 and an input/output interface 1204.

The input/output interface 1204 comprises an interface (RPS/Rx) 1211 for receiving robot position information, an interface (RPS/Tx) 1212 for emitting robot position information, an action interface 1209 for providing control signals to manoeuvring means (not shown), a sensing interface 1210 for sensing different physical influences via transducers (not shown), and a link interface 1213 for communicating with external devices.

Preferably, the interface RPS/Rx 1211 is embodied as shown in FIG. 11; and the interface RPS/Tx is embodied as shown in FIG. 9. The link interface 1213 is employed to allow communication with external devices e.g. a personal computer, a PDA, or other types of electronic data sources/data consumer devices. This communication can involve program download/upload of user created script programs and/or firmware programs. The interface can be of any interface type comprising electrical wire/connector types (e.g. RS323); IR types (e.g. IrDa); radio frequency types (e.g. Blue tooth); etc.

The action interface 1209 for providing control signals to manoeuvring means (not shown) is implemented as a combination of digital output ports and digital-to-analogue converters. These ports are used to control motors, lamps, sound generators, and other actuators.

The sensing interface 1210 for sensing different physical influences is implemented as a combination of digital input ports and analogue-to-digital converters. These input ports are used to sense activation of switches and/or degrees of temperature, sound pressure, etc.

The memory 1202 is divided into a data segment 1205 (DATA), a first code segment 1206 (BES) with a behaviour execution system, a second code segment 1207 with a functions library, and a third code segment 1208 with an operating system (OS).

The data segment 1205 is used to exchange data with the input/output interface 1204 (e.g. data provided by the buffer 1104 and data supplied for the buffers 904 and 905). Moreover, the data segment is used to store data related to executing programs.

The second code segment 1207 comprises program means that handle the details of using the interface means 1204. The program means are implemented as functions and procedures which are executed by means of a so-called Application Programming Interface (API).

The first code segment 1206 comprises program means implementing a programmed behaviour of the robot. Such a program is based on the functions and procedures provided by means of the Application Programming Interface.

The third code segment 1208 comprises program means for implementing an Operating System (OS) that handles multiple concurrent program processes, memory management etc.

The CPU is arranged to execute instructions stored in the memory to read data from the interface and to supply data to the interface in order to control the robot and/or communicate with external devices.

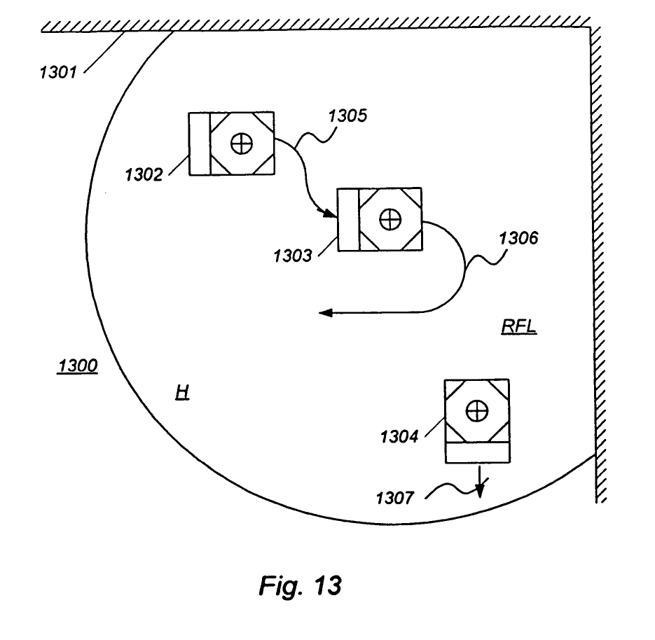

FIG. 13 shows three robots in a partially confined space. The robots 1302, 1303 and 1304 are equipped with transmitters and receivers for determining distance and direction to other robots and orientation of other robots. This information can be used to navigate a robot in response to the other robots. The robot 1302 is programmed to follow the robot 1303 e.g. via the route 1305. The robot 1303 is in turn programmed to seek away from the robot 1304 via the route 1306. The robot 1304 is programmed to move away from the other robots by moving backwards.

This scenario may change constantly depending on the actual mutual position and orientation of the robots, the programs controlling the robots etc.

Despite being used as toy robots in a living room, the invention can be used to control industrial robots for moving around among each other more autonomously.

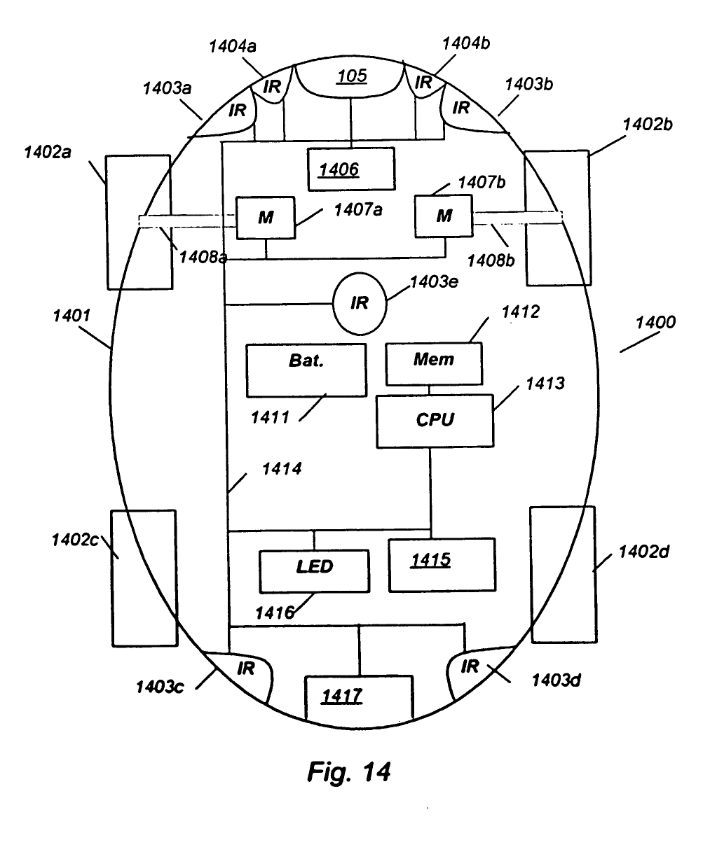

FIG. 14 shows a block-diagram of a toy robot. The toy robot 1400 according to a first embodiment of the invention comprises a housing 1401, a set of wheels 1402a-d driven by motors 1407a and 1407b via axes 1408a and 1408b. Alternatively or additionally, the toy robot may include different means for moving, such as legs, chains, or the like. It may also include other moveable parts, such as a propeller, arms, tools, a rotating head or the like. The toy robot further comprises a power supply 1411 providing power to the motor and the other electrical and electronic components of the toy robot. Preferably, the power supply 1411 includes standard batteries. The toy robot further comprises a central processor CPU 1413 responsible for controlling the toy robot 1400. The processor 1413 is connected to a memory 1412, which may comprise a ROM and a RAM or EPROM section (not shown). The memory 1412 may store an operating system for the central processor 1413 and firmware including low-level computer-executable instructions to be executed by the central processor 1413 for controlling the hardware of the toy robot by implementing commands such as “turn on motor”. Furthermore, the memory 1412 may store application software comprising higher level instructions to be executed by the central processor 1413 for controlling the behaviour of the toy robot. The central processor may be connected to the controllable hardware components of the toy robot by a bus system 1414.

The toy robot may comprise a number of different sensors connected to the central processor 1413 via the bus system 1414. In the example shown, the toy robot comprises an impact sensor 1405 for detecting when it gets hit and a light sensor 1406 for measuring the light level and for detecting blinks. The toy robot further comprises two infrared (IR) receivers 1404a-b for detecting and mapping other robots as described in the above. Alternatively or additionally, the toy robot may comprise other sensors, such as a shock sensor, e.g. a weight suspended in a spring providing an output when the toy robot is hit or bumps into something, or sensors for detecting quantities including time, taste, smell, light, patterns, proximity, movement, sound, speech, vibrations, touch, pressure, magnetism, temperature, deformation, communication, or the like.

The sensor signals generated by the sensors in response to external stimuli are routed via the bus 1414 to the central processor 1413, where they are processed according to the program instructions stored in the memory 1412. The processing may result in changes to variables and parameters stored in the memory 1412 and it may result in control signals generated by the central processor 1413 and routed via the bus 1414 to different hardware components controlling the actions of the toy robot. The active hardware components of the toy robot include the motor 1407, an LED 1416 for generating light effects, for example imitating a laser gun, and a piezo element 1415 for making sound effects. Other possible active components include an RGB-light transmitter for generating blended colour effects and thus expressing the internal state of the robot, such as its active behavioural state, or a mood light containing LEDs of different colours. Other actions may include movement, sound, heat, light, scent, or the like.

A special type of sensing and acting is communicating. For this purpose, the toy robot illustrated in FIG. 1 comprises five infrared transmitters 1403a-e for emitting infrared signals which, together with the infrared receivers 1404a-b, may be used for robot-to-robot communications. Preferably, the transmitter 1403e is an infrared diode, for example placed on top of the robot, emitting infrared light with a wavelength between 940 nm and 960 nm and driven by a current which is high enough for the emitted light to yield reflections from the walls of a room, e.g. a 6 by 6 meters room, that may be received by at least one of the receivers 1404a-b of another robot in the room. Preferably, the output power of the diodes 1403a-d may be controlled individually at different power levels, e.g. two power levels. The infrared transmitters 1403a-e may emit broadcast messages at different power levels in a predetermined ping cycle used for transmitting information to other robots and for the robot to be detectable by other robots.

Alternatively, a different number of transmitters and other means of communications, such as acoustic signals or other electromagnetic radiation may be used. The toy robot further comprises an interface connector 1417, for example a serial port for connecting the toy robot to an external device, such as a personal computer, a PDA, a mobile phone or the like. Other communication means include a user interface, such as buttons or a display for displaying pictures or text information.

In a preferred embodiment, the invention is embodied as a unit that can control a robot. Preferably the unit comprises motors for interconnection with shafts, axels, spindles or similar mechanical means for construction of a driving, climbing, walking or otherwise moving robot. The unit can be a part of a constructional toy building set.

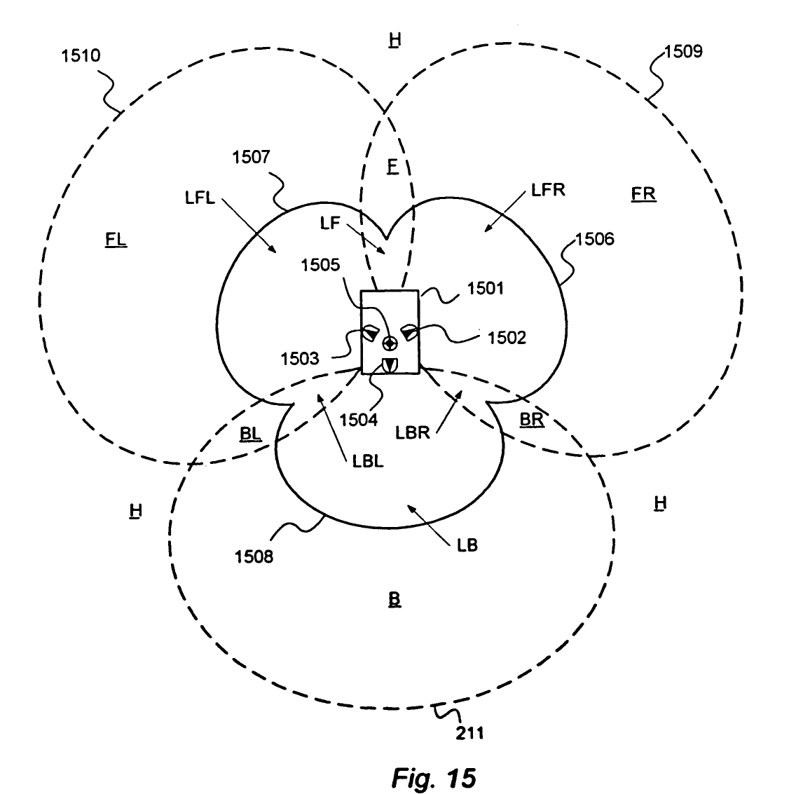

In addition or as an alternative to the above description, especially in connection with FIGS. 4 through 9 and 11, a further principle of operation is described in the following with reference to FIGS. 15 through 17.

FIG. 15 shows a toy robot with emitters emitting signals that are characteristic for each one of a number of zones that surround the robot The robot 1501 is shown with an orientation where the front of the robot is facing upwards.

The robot 1501 comprises four infrared light emitters 1502, 1503, 1504, and 1505, each emitting a respective infrared light signal. Preferably, the emitters are arranged to emit light at a wavelength between 940 nm and 960 nm.

The infrared light emitters 1502, 1503, and 1504 are mounted on the robot at different positions and at different angles to emit infrared light into zones FR, FL, and B as indicated by irradiance curves 1509, 1510, and 1511, respectively, surrounding the robot. The directions of these diodes are 60°, 300°, and 180°, respectively, with respect to the direction of forward motion of the robot. When the angle of irradiance of each of the diodes is larger than 120°, e.g. between 120° and 160°, the zones 1509 and 1510 overlap to establish a further zone F; similarly the zones 1510 and 1511 overlap to establish a zone BL, and zones 1509 and 1511 overlap to establish zone BR. The zones are defined by the radiation aperture and the above-mentioned position and angle of the individual emitters—and the power of infrared light emitted by the emitters.

The emitters 1502, 1503, and 1504 are controlled to emit infrared light at two different power levels; in the following these two power levels will be referred to as a low power level (prefix ‘L’) and a medium power level (prefix ‘M’).

The relatively large irradiance curves 1509, 1510, and 1511 represent zones within which a receiver is capable of detecting infrared light signals FR, FL and B emitted towards the receiver when one of the transmitters is transmitting at a medium power level. Likewise, the relatively small irradiance curves 1506, 1507, and 1508 represent zones within which a receiver is capable of detecting infrared light signals LFR, LFL and LB emitted towards the receiver when one of the transmitters is transmitting at a low power level. In one embodiment, the relatively large curves 1509, 1510, 1511 have a diameter of about 120-160 cm. The relatively small curves 1506, 1507, and 1508 have a diameter of about 30-40 cm.

The emitter 1505 is arranged to emit a signal at a high power level larger than the above medium power level to the surroundings of the robot. Since this signal is likely to be reflected from objects such as walls, doors etc., a corresponding irradiance curve is not shown—instead a capital H indicates this irradiance. High-power ping-signals should be detectable in a typical living room of about 6×6 metres.

Thus, the emitters 1502, 1503, and 1504 are arranged such that when operated at a medium power level (M), they establish mutual partly overlapping zones 1509, 1510, and 1511. Additionally, when the emitters 1502, 1503, and 1504 are operated at a low power level (L), they establish mutually partly overlapping zones 1506, 1507, and 1508. This allows for an accurate determination of the orientation of the robot 1501.

In the embodiment of FIG. 15, the overlap zones LF, LBR, and LBL are defined by a receiver being in the corresponding overlapping zone at medium power level, i.e. F, BR, and BL, respectively, and receiving a low power signal from at least one of the diode emitters 1502, 1503, and 1504.

Each of the infrared signals FR, FL, and B are encoded with information corresponding to a unique one of the infrared emitters thereby corresponding to respective zones of the zones surrounding the robot.

The infrared signals are preferably arranged as time-multiplexed signals wherein the information unique to the infrared emitters is arranged in mutually non-overlapping time slots.

In order to be able to determine, based on the signals, in which of the zones a detector is present, a detector system is provided with information of the relation between zone location and a respective signal.

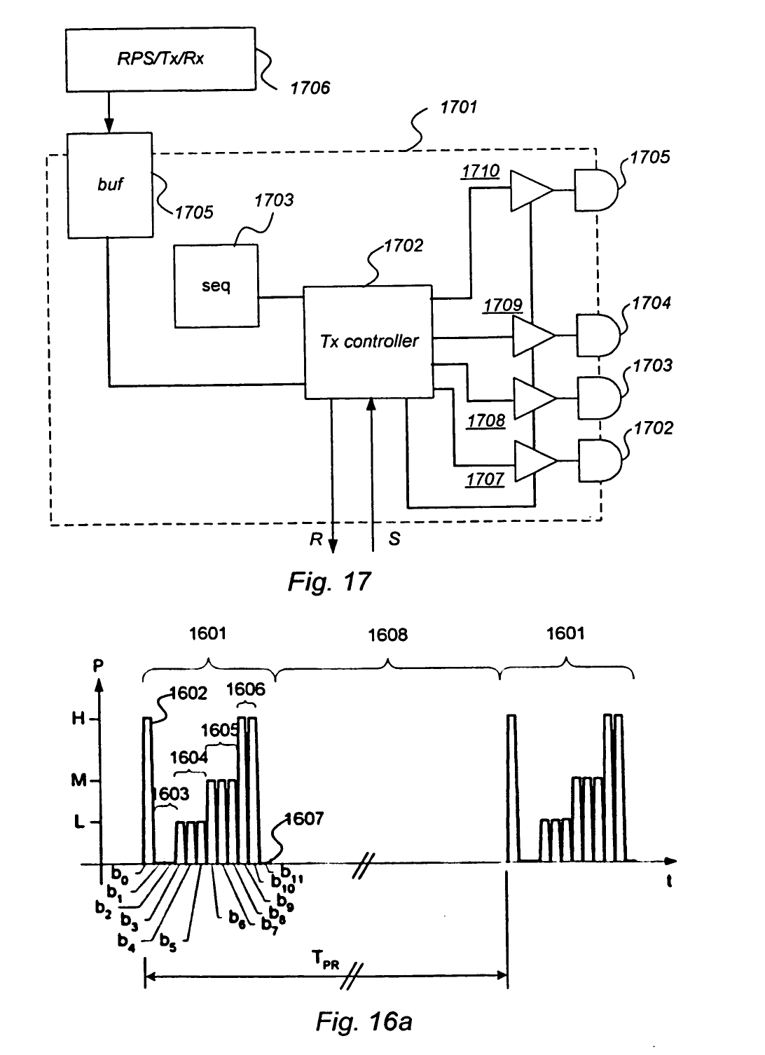

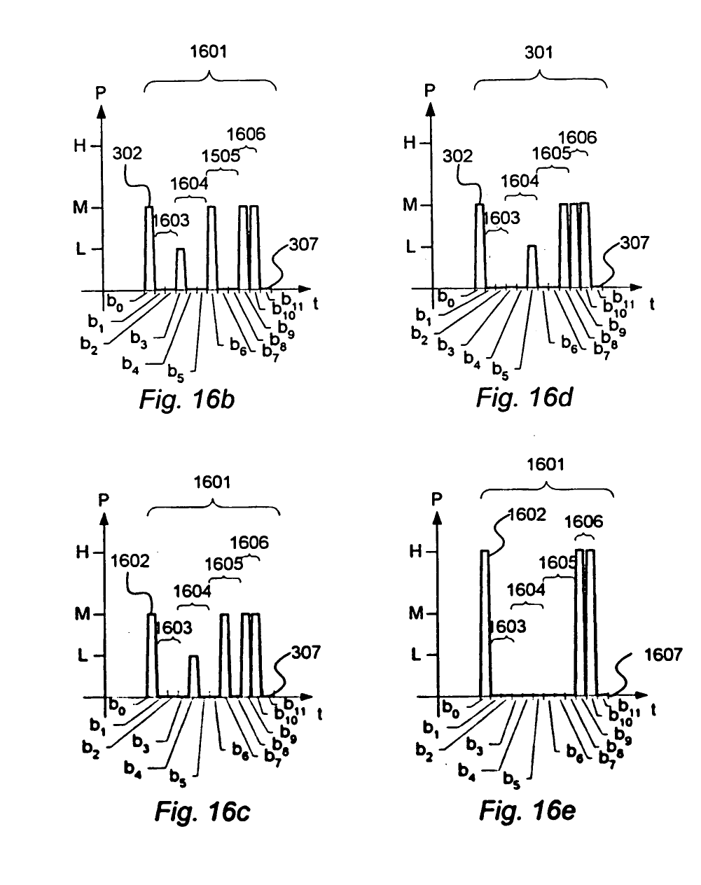

A preferred embodiment of a detection principle will be described in connection with FIGS. 16a-e.

In order for a transmitting robot to encode orientation and distance information and to transmit the information into the zones for subsequent decoding and interpretation in another receiving robot, a network protocol is used. The network protocol is based on ping-signals and message signals. These signals will be described in the following.

FIG. 16a shows the power levels used for transmitting ping-signals from the respective emitters, e.g. the emitters 1502, 1503, 1504, and 1505 of FIG. 15.

The power levels P are shown as a function of time t at discrete power levels L. M and H.

The ping signals are encoded as a position information bit sequence 1601 transmitted in a tight sequence. The sequence 1601 is transmitted in a cycle with a cycle time T_{PR}, leaving a pause 1608 between the tight sequences 1601. This pause is used to transmit additional messages and to allow other robots to transmit similar signals and/or for transmitting other information—e.g. message signals.

A position information bit sequence 1601 comprises twelve bits (b0-b11), a bit being transmitted at low power (L), medium power (M), or at high power (H). The first bit 1602 is transmitted by diode 205 at high power. In a preferred embodiment, this bit is also transmitted by the emitters 1502, 1503, and 1504 at medium power. By duplicating the high power bit on the other diodes with medium power, the range of reception is increased and it is ensured that a nearby receiver receives the bit even if the walls and ceiling of the room are poor reflectors. The initial bit is followed by two bits 1603 of silence where none of the diodes transmits a signal. The subsequent three bits 1604 are transmitted at low power level, such that each bit is transmitted by one of the diodes 202, 203, and 204 only. Similarly, the following three bits 1605 are transmitted at medium power level such that each of the diodes 202, 203, and 204 transmits only one of the bits 1605. The subsequent two bits 1606 are again transmitted by the diode 205 at high power level and, preferably, by the diodes 202, 203, and 204 at medium power level, followed by a stop bit of silence 1607.

Hence, each of the diodes 202, 203, 204, and 205 transmits a different bit pattern as illustrated in FIGS. 16b-e, where FIG. 16b illustrates the position bit sequence emitted by diode 202, FIG. 16c illustrates the position bit sequence emitted by diode 203, FIG. 16d illustrates the position bit sequence emitted by diode 204, and FIG. 16e illustrates the position bit sequence emitted by diode 205.

A receiving robot can use the received bit sequence to determine the distance to the robot which has transmitted the received bit pattern and the orientation of the transmitting robot, since the receiving robot can determine which ones of the zones of the transmitting robot the receiving robot is located in. This termination may simply be performed by means of a look-up table relating the received bit pattern to one of the zones in FIG. 2. This is illustrated by table 1.

TABLE 1

| Received position bit sequence | Zone |
|---|---|
| no signal | no robot present |
| 100000000110 | H |
| 100000100110 | FR |
| 100000010110 | FL |
| 100000001110 | B |
| 100000110110 | F |
| 100000101110 | BR |
| 100000011110 | BL |
| 100100100110 | LFR |
| 100010010110 | LFL |
| 100001001110 | LB |
| 100100110110, 100010110110, or 100110110110 | LF |
| 100100101110, 100001101110, or 100101101110 | LBR |
| 100010011110, 100001011110, or 100011011110 | LBL |

Table 1 shows how the encoded power level information in transmitted ping-signals can be decoded into presence, if any, in one of the zones of the transmitting robot. A zone is in turn representative of an orientation and a distance.

It is understood that the above principle may be applied to a different number of diodes and/or a different number of power levels, where a higher number of diodes increases the accuracy of the determination of orientation and higher number of power levels increases the accuracy of the distance measurement. This increase in accuracy is achieved at the expense of increasing the bit sequence and, thus, decreasing the transmission rate.

In one embodiment, the robot transmits additional messages, e.g. in connection with a ping signal or as a separate message signal. Preferably, the messages are transmitted in connection with a position information bit sequence, e.g. by transmitting a number of bytes after each position bit sequence. In one embodiment, the robot transmits a ping signal comprising a position information bit sequence followed by header byte, a robot ID, and a checksum, e.g. a cyclic redundancy check (CRC). Additionally or alternatively other information may be transmitted, such as further information about the robot, e.g. speed, direction of motion, actions, etc., commands, digital tokens to be exchanged between robots, etc.

Each byte may comprise a number of data bits, e.g. 8 data bits, and additional bits, such as a start bit, a stop bit, and a parity bit. The bits may be transmitted at a suitable bit rate, e.g. 4800 baud. Preferably, the additional message bytes are transmitted at high power level by diode 205 and at medium power level by the diodes 202, 203, and 204.

Preferably, the robot ID is a number which is unique to the robot in a given context. The robot ID enables robots to register and maintain information on fellow robots either met in the real world or over the Internet. The robot may store the information about other robots as part of an external state record, preferably as a list of known robots. Each entry of that list may contain information such as the robot ID, mapping information, e.g. direction, distance, orientation, as measured by the sensors of the robot, motion information, game related information received from the respective robot, e.g. an assignment to a certain team of robots, type information to be used to distinguish different groups of robots by selection criteria, an identification of a robot controller controlling the robot, etc.

When a robot receives a broadcast message from another robot, it updates information in the list. If the message originator is unknown, a new entry is made. When no messages have been received from a particular entry in the list for a predetermined time, e.g. longer than two broadcast repetitions, a robot entry is marked as not present

In order to keep the robot ID short, e.g. limit it to one byte, and allow a unique identification of a robot in a given context, an arbitration algorithm may be used among the robots present inside a communication range, e.g. within a room. For example, a robot receiving a ping signal from another robot with the same ID may select a different ID.

In comparing the principle explained in connection with FIGS. 5a/5b and FIGS. 16a through 16e it can be seen that the means for emitting the signals into the surroundings of the robot is controlled to emit the signals at respective power levels, at which power levels the signals comprise information for identifying the specific power level. However, in connection with FIGS. 5a/5b it can be seen that one or several bytes are transmitted at a given power level, whereas in connection with FIGS. 16a through 16e it can be seen that individual bits within a sequence of bits are transmitted at different power levels. By means of the principle described in connection with FIGS. 16a through 16e the information necessary for determining a distance to the transmitting robot can be transmitted in a shorter signal that is, by means of a less number of bits.

Regarding deduction of in which zone a remote robot is present zones created by overlapping zones (eg 410 and 407) can be used to a more or less extent. With regard to FIG. 4 a relatively fine resolution is achieved by using all the spatial zones including zones created by overlapping zones to deduce in which zone a remote robot is present. However, with regard to FIG. 15 it is shown that two or more spatial zones, created by overlapping zones, are interpreted as a single zone in deducing in which zone a remote robot is present. Thereby, a desired—coarser—resolution is achievable in the deduction.

FIG. 17 shows a block diagram of a communications system for transmitting ping-signals and message-signals. The system 1701 receives ping-signals (e.g. the header, robot ID and CRC bytes) and message signals via a buffer 1705. The ping- and message-signals are provided by an external system (not shown) via a transmission interface 1706. The communications system 1701 is thus able to receive information from the external system, which in turn can be operated asynchronously of the communications system.

The system comprises a memory 1703 for storing the respective position bit sequences for the different diodes as described in connection with FIGS. 16a-e.

A controller 1702 is arranged to receive the ping- and message-signals, prefix the corresponding bit sequences retrieved from the memory 1703 and control the infrared light transmitters 202, 203, 204, and 205 via amplifiers 1707, 1708, 1709, and 1710. The power levels emitted by the emitters 1502, 1503, 1604 and 1505 are controlled by adjusting the amplification of the amplifiers 1707, 1708, 1709 and 1710. The signal S provided to the controller is a binary signal indicative of whether there is communication silence that is, no other signals that might possibly interfere with signals to be emitted are detectable. The controller further provides a signal R indicating when a signal is transmitted.

When the transmitters are infrared light diodes, the diodes are preferably mounted on a printed circuit board (PCB). The PCP is arranged substantially parallel with a plane of movement of the unit. The diodes emitting low and medium power signals are mounted to radiate light according to desired spatial zones defined at least for the plane of movement. The diode(s) emitting high power signals is/are mounted on the PCB to radiate light in a direction perpendicular to the PCB, but not necessarily restricted to that direction.

Generally, it should be noted that, the term zone comprises a predetermined set or range of positions relative to the robot, e.g. a certain sector relative to the robot, a certain area within a plane parallel to the surface on which the robot moves, or the like. Hence, when a robot detects another robot in one of its zones, the two robots have a predetermined positional relationship, e.g. the distance between them may be within a certain range, the other robot may be located in a direction relative to the direction of motion of the detecting robot which is within a certain range of directions, or the like.

Generally, power levels are communicated by coded bytes or bit patterns, however, other modulation schemes can be applied without departing from the scope of the invention. In preferred embodiments amplitude modulation (AM), frequency modulation (FM), or pulse width modulation (PWM) can be applied for communicating power levels at which a signal is transmitted.

The invention can be incorporated into robots with means for moving around, but preferably aspects of the invention relating to transmission of information is embodied into remote control units. The remote control units can be embodied as units, which can be placed among moving robots and/or used as handheld remote control units.

Generally, the term ‘overlapping’ refers to a space irradiated by two or more transmitters. The space will be a 3D space but as appears from the drawing, this overlap may be defined in a single plane (eg the plane of the paper).

1. A system for transmitting information about the orientation of a robot, comprising:
means for emitting signals to multiple zones (208,209, . . . ,215) at predetermined locations around and relative to the robot, wherein the signals carry information that is specific to the individual zones around the robot;
characterized in that
the information (FR, F, FL, BL, L, . . . FR) that is specific to the individual zones is time-multiplexed to multiple timeslots (t1,t2, . . . ,t7).

2. A system according to claim 1, characterized in that the information that is specific to the individual zones is emitted as a time-multiplexed signal divided both temporally (t1,t2, . . . ,t7) and spatially (208,209, . . . ,215) into one or more zones (F,FL,L,BL, . . . ).

3. A system according to claim 1, characterized in that the means are arranged as individual emitters (202,203, . . . ,207) mounted with a mutual distance and at mutually offset angles.

4. A system according to claim 1, characterized in that an emitter is arranged to create a space within which a specified least intensity level for a signal that carries information specific for the zone is detectable.

5. A system according to claim 1, characterized in that emitters are arranged to create a zone within which a specified least intensity level for a first signal (FL;BR) and a second signal (BL;FR) can be measured, where the first and second signal carry information specific for a respective zone (210;213, 211;208) to thereby create a third zone (L;R) as the common space (214;215) of two zones.

6. A system according to claim 5, characterized in that the information (L;R) that is specific to the third zone is composed of at least portions of the first signal (FL;BR) and the second signal (BL;FR).

7. A system according to claim 5, characterized in that the information (L;R) that is specific to the third zone extends temporally over more than one timeslot (t3,t4;t6,t7).

8. A system according to claim 1, characterized in that at least one emitter (413) is controlled to transmit message-signals with information about the robot to other robots.

9. A system according to claim 1, characterized in that a first robot is arranged to wait for a situation where communication silence can be detected before a transmission of a signal is started.

10. A system according to claim 9, characterized in that the first robot is arranged to transmit the signals carrying information that is specific to individual zones in a sufficiently tight sequence to avoid that other similar robots in proximity of the first robot is able to detect a situation where communication silence (S) is present.

11. A system for receiving information about the orientation of a robot, comprising:
means for receiving signals that carry information that is specific to one of multiple zones (208,209, . . . ,215) around and relative to the robot (201); and
means for extracting the information specific to an individual zone and converting that information into information that represents the orientation of the robot;
characterized in that
the orientation of the robot is deduced by determining whether two signals that each carries information that is specific to one of multiple zones around and relative to the robot can be received in at least two consecutive timeslots (t1,t2, . . . ,t7);
in the positive, combining the at least two signals (FL,BL; BR,FR) to determine the orientation of the robot (201).

12. A system according to claim 11, characterized in that, in the negative, determining the orientation of the robot based on the signal received in a first of the two consecutive timeslots (t1,t2, . . . ,t7).

13. A system according to claim 11, characterized in that the system further comprises program means for controlling physical actions of a robot in response to the received signals that represent the orientation of another robot.

14. A toy building set comprising a toy unit according to claim 11, characterized in that the toy unit comprises coupling means for inter-connecting with complementary coupling means on toy building elements.

15. A system for transmitting information about the distance between the system and a robot, comprising:
means for emitting signals to the surroundings of the robot;
characterized in
said means being controlled to emit the signals at respective power levels (L,M,H), at which power levels the signals comprise information (LBR,MBR,H; bo b₁, . . . b₁₁) for identifying the specific power level.

16. A system according to claim 15, characterized in that the power levels are discrete power levels distributed as non-linear power levels.

17. A system according to claim 15, characterized in that power levels of the signals or signal portions are mixed within a time-interval over which the information for identifying the specific power level is transmitted.

18. A system according to claim 15, characterized in that the signals each comprise a set of bits (b₀,b₁ . . . ,b₁₁), which bits occur in a predetermined, but mixed sequence.

19. A system according to claim 15, characterized in comprising means for emitting signals to multiple zones at predetermined locations around and relative to the robot, wherein the signals carry information that is specific to the individual zones around the robot.

20. A system according to claim 15, characterized in that at least one emitter is controlled to transmit (807) message-signals with information about the robot to other robots.

21. A system according to claim 15, characterized in that a first robot is arranged to wait for a situation where communication silence can be detected before a transmission of a signal is started.

22. A system according to claim 21, characterized in that the first robot is arranged to transmit the signals at the respective power levels in a sufficiently tight sequence to avoid that other similar robots in proximity of the first robot are able to detect a situation where communication silence (S) is present.

23. A system for receiving information about the distance between the system and a transmitter, comprising:
means for receiving signals with information for identifying a specific power level at which the signal is transmitted; and
means for converting that information into information that represents distance between the system and a transmitter that transmits the signals.

24. A system according to claim 24, characterized in comprising means for converting a received signal into a binary signal based on a specified threshold value.

25. A system according to claim 23, characterized in that the distance is determined as a discrete value by decoding a sequence of bits representing the received signal as a binary signal.

26. A system according to claim 21, characterized in that the distance is provided as a digital value.

27. A system according to claim 26, characterized in that a sequence of consecutive digital values represents non-linear distributed distances.

28. A system for determining the direction to a robot characterized in that the system comprises:
means for receiving a signal from a remote robot, and determining a direction to the remote robot by determining which of multiple receivers that received the signal;
characterized in that
a direction is determined as a direction from which two or more receivers can receive the signal.

29. A system according to claim 28, characterized in that a precondition for determining the direction is that the receivers can receive the signal simultaneously.
